(19) United States
(12) Patent Application Publication
(10) Pub. No.: US 2021/0281702 A1
(43) Pub. Date: Sep. 9, 2021

(54) PRINTING APPARATUS AND METHOD FOR CONTROLLING PRINTING APPARATUS

(71) Applicant: SEIKO EPSON CORPORATION, Tokyo (JP)

(72) Inventor: Akio TAKAMOTO, Shiojiri (JP)

(21) Appl. No.: 17/191,757

(22) Filed: Mar. 4, 2021

(30) Foreign Application Priority Data
Mar. 6, 2020 (JP) 2020-038521

(51) Int. Cl. H04N 1/00; G06F 3/12

(52) U.S. Cl. CPC H04N 1/00901; G06F 3/1204; H04N 1/00907; G06F 3/123

(57) ABSTRACT

A printing apparatus that is communicable with an external apparatus and performs printing by using first electric power supplied from an external power supply, the printing apparatus includes a storage section, a connector which is connectable to a cable and to which second electric power is supplied from the external apparatus via the cable, and a control section, and the control section acts as a storage that stores information in the storage section when the first electric power is not supplied from the external power supply but the second electric power is supplied from the external apparatus via the connector and acts as a device that performs the printing when the first electric power is supplied from the external power supply.

The present application is based on, and claims priority from JP Application Serial Number 2020-038521, filed Mar. 6, 2020, the disclosure of which is hereby incorporated by reference herein in its entirety.

### BACKGROUND

### 1. Technical Field

The present disclosure relates to a printing apparatus and a method for controlling the printing apparatus.

### 2. Related Art

Research and development of a printing apparatus that prints an image on a printing medium is underway.

In this regard, there is a known printing apparatus that after powered on, reads setting information stored in an external storage apparatus and writes the read setting information on a storage section to set the setting information in the printing apparatus itself (see JP-A-2017-052296).

In the printing apparatus described in JP-A-2017-052296, to store the setting information in the storage section, it is necessary to connect and disconnect the external storage apparatus at a timing determined in advance. The connection and disconnection of the external storage apparatus is cumbersome for a user of the printing apparatus. The printing apparatus is therefore prone to wrong operation.

### SUMMARY

To solve the problem described above, an aspect of the present disclosure relates to a printing apparatus that is communicable with an external apparatus and performs printing by using first electric power supplied from an external power supply, the printing apparatus including a storage section, a connector to which a cable used both to communicate with the external apparatus and supply second electric power from the external apparatus is connected, and a control section, and the control section transmits information representing that the printing apparatus acts as a storage that stores information in the storage section to the external apparatus when the first electric power is not supplied from the external power supply but the second electric power is supplied from the external apparatus via the connector and transmits information representing that the printing apparatus acts as a device that performs the printing to the external apparatus when the first electric power is supplied from the external power supply.

Another aspect of the present disclosure relates to a method for controlling a printing apparatus that is communicable with an external apparatus and performs printing by using first electric power supplied from an external power supply, the printing apparatus including a storage section and a connector to which a cable used both to communicate with the external apparatus and supply second electric power from the external apparatus is connected, the method for controlling a printing apparatus including transmitting information representing that the printing apparatus acts as a storage that stores information in the storage section to the external apparatus when the first electric power is not supplied from the external power supply but the second electric power is supplied from the external apparatus via the connector and transmitting information representing that the printing apparatus acts as a device that performs the printing to the external apparatus when the first electric power is supplied from the external power supply.

### BRIEF DESCRIPTION OF THE DRAWINGS

FIG. 1 shows an example of the external appearance of a printing apparatus.

FIG. 2 shows an example of the configuration of hardware provided in the printing apparatus.

FIG. 3 shows an example of the procedure of the process of causing the printing apparatus to initiate an action according to supplied electric power.

FIG. 4 shows an example of the procedure of the process of prohibiting the printing apparatus from acting as a storage.

FIG. 5 shows a case where the printing apparatus acting as the storage receives setting information from an external apparatus and an example of the procedure of the process of causing the printing apparatus to store the received setting information.

FIG. 6 shows a case where a second printing apparatus is connected as the external apparatus to the printing apparatus and an example of the procedure of the process of causing the printing apparatus to transmit the setting information to the second printing apparatus in response to a trigger representing that a predetermined first condition is satisfied.

FIG. 7 shows an example of the procedure of the process of causing the printing apparatus to set the setting information stored in a nonvolatile storage section of printing apparatus.

FIG. 8 shows an example of the procedure of the process of causing the printing apparatus to update the setting information when set setting information is changed.

FIG. 9 shows an example of the printing apparatus packed in a storage box.

FIG. 10 shows another example of the printing apparatus packed in a storage box.

FIG. 11 shows still another example of the printing apparatus packed in a storage box.

### DESCRIPTION OF EXEMPLARY EMBODIMENTS

### Embodiment

An embodiment according to the present disclosure will be described below with reference to the drawings.

### Configuration of Printing Apparatus

The configuration of a printing apparatus 10 according to the embodiment will first be described.

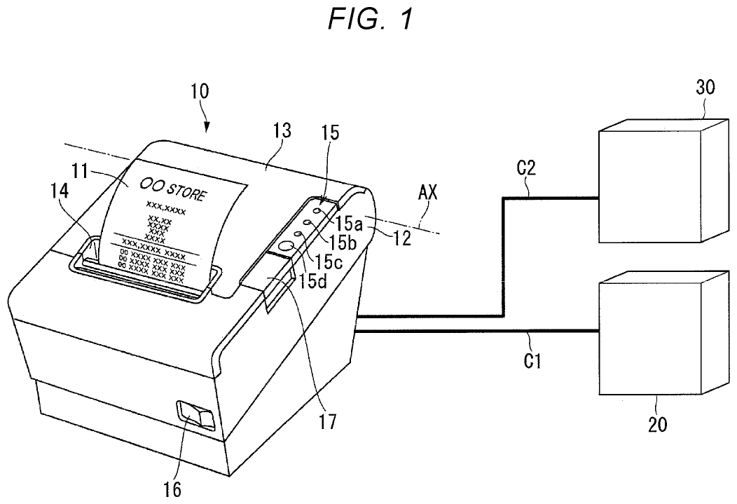

FIG. 1 shows an example of the external appearance of the printing apparatus 10.

The printing apparatus 10 is a thermal printer. More specifically, the printing apparatus 10 is, for example, a direct thermal printer that records an image in a thermosensitive manner by using a thermal line head that is not shown in FIG. 1. The printing apparatus 10 may instead be another thermal printer in place of a direct thermal printer. The printing apparatus 10 may be another type of printer, such as a dot impact printer or an inkjet printer, instead of a thermal printer.

The printing apparatus 10 performs printing on an elongated recording sheet 11 drawn from a rolled sheet that is not shown but is accommodated in the printing apparatus 10.

The printing apparatus 10 includes a main body enclosure 12 and a cover enclosure 13, as shown in FIG. 1. In the printing apparatus 10, the main body enclosure 12 and the cover enclosure 13 each form the exterior of the printing apparatus 10.

Out of the enclosures that form the exterior of the printing apparatus 10, the main body enclosure 12 is an enclosure that can accommodate the rolled sheet.

The main body enclosure 12 is provided with an ejection port 14, via which the recording sheet 11 is ejected. A cutting mechanism that is not shown is disposed in a position inside the ejection port 14. The cutting mechanism is a mechanism that partially or completely cuts a recording sheet portion of the recording sheet 11 that is the portion having undergone printing off a recording sheet portion of the recording sheet 11 that is the portion not having undergone the printing.

The main body enclosure 12 is further provided with a display section 15. The display section 15 includes an LED display sections 15a, 15b, and 15c each including an LED (light emitting diode) as a light source. The display section 15 displays, for example, the operating state of the printing apparatus 10 in the form of the lighting states of the LED display sections 15a, 15b, and 15c. The display section 15 also includes a switch 15d, which accepts a user's operation.

The main body enclosure 12 is further provided with a power switch 16. The power switch 16 is a power switch of the printing apparatus 10.

Out of the enclosures that form the exterior of the printing apparatus 10, the cover enclosure 13 is an enclosure openable and closable with respect to the main body enclosure 12. The cover enclosure 13 is connected to the main body enclosure 12 via a predetermined pivotal axis AX. That is, the cover enclosure 13 is pivotable around the pivotal axis AX relative to the main body enclosure 12.

The main body enclosure 12 is provided with an open button 17. When the open button 17 is pressed down, the cover enclosure 13 opens. When the cover enclosure 13 is opened, the interior of the main body enclosure 12 is open to the outside . When the interior of the main body enclosure 12 is open to the outside, a roll sheet accommodation section that is not shown but is located in the main body enclosure 12 is exposed. That is, when the cover enclosure 13 is opened, the state of the printing apparatus 10 transitions to the state in which the interior of the main body enclosure 12 is open to the outside.

When the cover enclosure 13 is closed, the interior of the main body enclosure 12 is closed from the outside. When the interior of the cover enclosure 13 is closed from the outside, the state of the printing apparatus 10 transitions a state in which general operation can be normally performed.

The main body enclosure 12 is further provided with a first connector 18. In FIG. 1, the first connector 18, which is located on the rear side of the printing apparatus 10, is not visible. The first connector 18 is a connector into which a first cable C1 is inserted so that the first connector 18 connected to the first cable C1. The first cable C1 is a power supply cable that connects an external power supply 20 to the printing apparatus 10. The external power supply 20 is a power supply apparatus that supplies the printing apparatus 10 with first electric power. In the example shown in FIG. 1, the printing apparatus 10 is connected to the external power supply 20 via the first cable C1.

The external power supply 20 is, for example, an AC (alternating current) adapter. In this case, the external power supply 20 converts electric power supplied from a commercial power supply that is not shown into the first electric power and supplies the printing apparatus 10 with the converted first electric power. The voltage of the first electric power is, for example, 24 volts. The voltage of the first electric power may be lower or higher than 24 volts. In place of the AC adapter, the external power supply 20 may be a storage battery or any other power supply apparatus capable of supplying the printing apparatus 10 with the first electric power. To prevent complication of the contents of the FIG. 1, a cable that connects the commercial power supply to the external power supply 20 is omitted.

The main body enclosure 12 is further provided with a detection section S, which detects that the first electric power is supplied to the first connector 18. In FIG. 1, the detection section S, which is located in the main body enclosure 12, is not visible. The detection section S is, for example, a circuit that detects whether the voltage of the first electric power supplied via the first cable C1 is present or not. The detection section S may be, for example, another circuit, another member, or another apparatus capable of detecting that the first electric power is supplied to the first connector 18. The detection section S may, for example, be a contact sensor that detects that the first cable 1 is connected to the first connector 18. In this case, the detection section S detects that the first cable C1 is connected to the first connector 18 in the form of the state in which the first electric power is supplied to the first connector 18. The first connector 18 is an example of a power supply connector. The first cable C1 is an example of a power supply cable.

The main body enclosure 12 is further provided with a second connector 19. In FIG. 1, the second connector 19, which is located on the rear side of the printing apparatus 10, is not visible. The second connector 19 is a connector into which a second cable C2 is inserted so that the second connector 19 connected to the second cable C2. The second cable C2 is a cable used both to communicate with an external apparatus 30 and to supply second electric power from the external apparatus 30. The second cable C2 is, for example, a USB (universal serial bus) cable. In this case, the second connector 19 is a USB connector. When the second cable C2 is a cable used both to communicate with the external apparatus 30 and to supply the second electric power from the external apparatus 30 in place of the USB cable, the second cable C2 may be another cable such as a Lightning (registered trademark) cable. The second connector 19 is an example of a connector. The second cable C2 is an example of a cable.

The external apparatus 30 is an apparatus connected to the printing apparatus 10 via the second cable C2. The external apparatus 30 is an apparatus separate from the printing apparatus 10. The external device 30 may be any apparatus connectable to the printing apparatus 10 via the second cable C2 and separate from the printing apparatus 10. In the example shown in FIG. 1, the printing apparatus 10 is connected to the external apparatus 30 via the second cable C2.

The external apparatus 30 is, for example, an information processor processing apparatus or a second printing apparatus. The information processing apparatus is, for example, a laptop PC (personal computer), a tablet PC, a multifunctional mobile phone terminal (smartphone), a PDA (personal digital assistant), a desktop PC, and a workstation. The information processing apparatus may be another type of information processing apparatus in place of any of the apparatuses described above. The second printing apparatus may be any printing apparatus having at least the function of the printing apparatus 10. The second printing apparatus is, for example, another printing apparatus 10 or a printing apparatus having upward compatibility with the printing apparatus 10.

### Configuration of Hardware Provided in Printing Apparatus

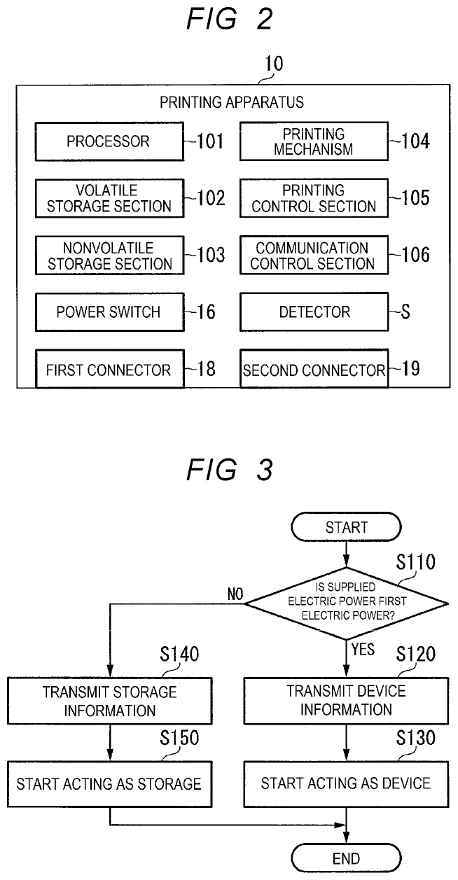

The configuration of hardware provided in the printing apparatus 10 will be described below with reference to FIG. 2. FIG. 2 shows an example of the configuration of the hardware provided in the printing apparatus 10.

The printing apparatus 10 includes a processor 101, a volatile storage section 102, a non-volatile storage section 103, a printing mechanism 104, a printing control section 105, and a communication control section 106, as shown in FIG. 2. FIG. 2 shows the power switch 16, the first connector 18, the detection section S, and the second connector 19 as well as the processor 101, the volatile storage section 102, the non-volatile storage section 103, the printing mechanism 104, the printing control section 105, and the communication control section 106 for convenience of the description. The printing apparatus 10 may have a configuration including not only the processor 101, the volatile storage section 102, the non-volatile storage section 103, the printing mechanism 104, the printing control section 105, and the communication control section 106 but another hardware functional section.

The processor 101 is, for example, a CPU (Central Processing Unit) . The processor 101 may be another processor, such as an FPGA (Field Programmable Gate Array) . The processor 101 is an example of a control section.

The volatile storage section 102 is a storage apparatus having a volatile storage area. The volatile storage section 102 is, for example, a RAM (random access memory) . The volatile storage section 102 may be another storage apparatus having a volatile storage area.

The nonvolatile storage section 103 is a storage apparatus having a nonvolatile storage area. The non-volatile storage section 103 is, for example, a flash memory. The nonvolatile storage section 103 may be another storage apparatus having a nonvolatile storage area. The nonvolatile storage section 103 is an example of a storage.

The printing mechanism 104 is a mechanism including, for example, a transport roller, a transport motor, a thermal line head, and the cutting mechanism. The transport roller transports the recording sheet 11. The transport motor drives the transport roller along with a variety of gears . The thermal line head prints an image on the recording sheet 11 transported by the transport motor. The cutting mechanism cuts the recording sheet 11 having undergone the printing performed by the thermal line head.

The printing apparatus 10 may be configured to include a cutting mechanism as a mechanism separate from the printing mechanism 104. In this case, in the printing apparatus 10, when electric power is supplied to the printing mechanism 104, the electric power is also supplied to the cutting mechanism. Further, in this case, when the supply of the electric power to the printing mechanism 104 is cut off in the printing apparatus 10, the supply of the electric power to the cutting mechanism is also cut off. Further, in this case, in the printing apparatus 10, the electric power supplied to the printing mechanism 104 is the same electric power supplied to the cutting mechanism. That is, in this case, in the printing apparatus 10, when the first electric power is supplied to the printing mechanism 104, the first electric power is also supplied to the cutting mechanism. The printing apparatus 10 may be configured to include a transport mechanism including a transport roller and a transport motor as a mechanism separate from the printing mechanism 104. In this case, in the printing apparatus 10, when electric power is supplied to the printing mechanism 104, the electric power is also supplied to the transport mechanism. Further, in this case, in the printing apparatus 10, when the supply of the electric power to the printing mechanism 104 is cut off, the supply of the electric power to the transport mechanism is also cut off. Moreover, in this case, in the printing apparatus 10, the electric power supplied to the printing mechanism 104 is the same electric power supplied to the transport mechanism. That is, in this case, in the printing apparatus 10, for example, when the first electric power is supplied to the printing mechanism 104, the first electric power is also supplied to the transport mechanism.

The printing control section 105 is a circuit that drives the printing mechanism 104. The printing control section 105 is controlled by the processor 101.

The communication control section 106 is a circuit that controls communication with an external apparatus via the second connector 19. That is, in the example show in FIG. 1, the communication control section 106 controls the communication with the external apparatus 30 via the second connector 19. The communication control section 106 is controlled by the processor 101. The communication control section 106 may be configured to include a processor. In this case, out of the functions of the processor 101, the processor provided in the communication control section 106 may have the function of controlling the communication control section 106. In this case, the processor provided in the communication control section 106 is an example of the control section. The communication control section 106 includes a buffer. The processor 101 can use the buffer provided in the communication control section 106 in place of the volatile storage section 102 when the buffer has an increased storage area.

Different Actions of Printing Apparatus that Vary in Accordance with Electric Power Supplied to Printing Apparatus

The action of the printing apparatus 10 when the first electric power is supplied from the external power supply 20 differs from the action when the second electric power is supplied from the external apparatus 20. In view of the fact described above, different actions of the printing apparatus 10 that vary in accordance with the electric power supplied to the printing apparatus 10 will be described below.

The printing apparatus 10, when the first electric power is supplied thereto from the external power supply 20, acts as a device that performs printing (hereinafter simply referred to as device) irrespective of whether or not the printing apparatus 10 is connected to the external apparatus 30. Therefore, when the external apparatus 30 is connected to the printing apparatus 10 in this case, the printing apparatus 10 transmits device information to the connected external apparatus 30. The device information is information representing that the printing apparatus 10 acts as the device. The device information is, for example, a device descriptor containing a device class code representing that the printing apparatus 10 is the device. The device information is another piece of information representing that the printing apparatus 10 can act as the device. The external apparatus 30 connected to the printing apparatus 10 in this case can identify the situation in which the printing apparatus 10 in this case acts as the device.

On the other hand, when the first electric power is not supplied from the external power supply 20 to the printing apparatus 10, and when the second electric power is supplied thereto from the external apparatus 30 via the second connector 19, the printing apparatus 10 acts as a storage that stores information in the nonvolatile storage section 103. Therefore, in this case, the printing apparatus 10 transmits storage information to the connected external apparatus 30. The storage information is, for example, a device descriptor containing a mass storage class code representing that the printing apparatus 10 is the storage. The storage information may be another piece of information representing that the printing apparatus 10 can act as the storage. The external apparatus 30 connected to the printing apparatus 10 in this case can therefore identify the situation in which the printing apparatus 10 in this case acts as the storage.

### Process of Causing Printing Apparatus to Initiate Action According to Supplied Electric Power

The process of causing the printing apparatus 10 to initiate an action according to the supplied electric power will be described with reference to FIG. 3. FIG. 3 shows an example of the procedure of the process of causing the printing apparatus 10 to initiate an action according to the supplied electric power. The following description will be made, by way of example, of a case where the external power supply 20 is connected to the printing apparatus 10 via the first cable C1 and the external apparatus 30 is connected to the printing apparatus 10 via the second cable C2 at a timing before the process in step S110 shown in FIG. 3 is carried out. In this case, when the state of the power switch 16 is on, the first electric power from the external power supply 20 to the printing apparatus 10 is initiated, whereas when the state of the power switch 16 is off, the second electric power from the external apparatus 30 to the printing apparatus 10 is initiated. The following description will be made, by way of example, of a case where the supply of the first or second electric power to the printing apparatus 10 is initiated at the timing described above.

When electric power is supplied, the processor 101 evaluates whether or not the supplied electric power is the first electric power (step S110). A method for allowing the processor 101 to evaluate whether or not the supplied electric power is the first electric power may be a known method or a method to be developed in the future.

When the result of the evaluation shows that the supplied electric power is the first electric power (YES in step S110), the processor 101 transmits the device information to the external apparatus 30 (step S120).

The processor 101 then causes the printing apparatus 10 to start acting as the device (step S130) and terminates the process in the flow shown in FIG. 3. The process in step S120 and the process in step S130 may be carried out concurrently or in the reversed order.

On the other hand, when the result of the evaluation shows that the supplied electric power is not the first electric power (NO in step S110) , the processor 101 determines that the supplied electric power is the second electric power. The processor 101 then transmits the storage information to the external apparatus 30 (step S140).

The processor 101 then causes the printing apparatus 10 to start acting as the storage (step S150) and terminates the process in the flow shown in FIG. 3. The process in step S140 and the process in step S150 may be carried out concurrently or in the reversed order.

As described above, when the first electric power from the external power supply 20 is not supplied to the printing apparatus 10, and when the second electric power is supplied from the external apparatus 30 to the printing apparatus 10 via the second connector 19, the printing apparatus 10 transmits to the external apparatus 30 the information representing that the printing apparatus 10 acts as the storage that stores information in the nonvolatile storage section 103, whereas when the first electric power from the external power supply 20 is supplied to the printing apparatus 10, the printing apparatus 10 transmits to the external apparatus 30 the information representing that the printing apparatus 10 acts as the device that performs printing.

### Method for Setting Setting Information in Printing Apparatus

A method for setting setting information in the printing apparatus 10 when the printing apparatus 10 acts as the device differs from the method when the printing apparatus 10 acts as the storage. In view of the fact described above, the method for setting the setting information in the printing apparatus 10 will be described below.

The setting information is information containing a variety of pieces of information set in the printing apparatus 10. The setting information contains, for example, printing setting information, communication setting information, and firmware information.

The printing setting information is information containing a variety of pieces of information set in the printing apparatus 10 in association with the printing performed by the printing apparatus 10. The printing setting information contains, for example, part or entirety of font information, registered images, printing density information, printing speed information, and other pieces of information. The font information is information representing a font used by the printing apparatus 10 in the printing. The registered images are each an image to be printed as a background image on the recording sheet 11. Examples of the registered images may include a shop logo, a mark indicating a confidential document, and a tint block image. The printing density information is information representing the density of an image to be printed on by the printing apparatus 10 the recording sheet 11. The printing speed information is information representing the speed at which the printing apparatus 10 prints an image on the recording sheet 11.

The communication setting information is information representing the communication with another apparatus over a network and set in the printing apparatus 10. The communication setting information contains, for example, part or entirety of an IP (Internet Protocol) address, a subnet mask, a gateway, access point information, and security information. The access point information is information representing an access point to which the printing apparatus 10 is wirelessly connected and is, for example, an SSID (service set identifier). The security information is information on security in the communication performed by the printing apparatus 10. The security information contains, for example, part or entirety of information representing a WEP (wired equivalent privacy) key and information representing a WPS (Wi-Fi protected setup). Wi-Fi is a registered trademark.

The firmware information is information on firmware installed in the printing apparatus 10. The firmware information contains, for example, part or entirety of firmware installed in the printing apparatus 10 and information for updating the firmware installed in the printing apparatus 10.

The setting information is set in the printing apparatus 10 that acts as the device via the information processing apparatus connected as the external apparatus 30 to the printing apparatus 10. Specifically, setting information according to operation accepted from the user is transmitted from the information processing apparatus to the printing apparatus 10. The following description will be made on the assumption that the setting information transmitted from the information processing apparatus to the printing apparatus 10 is referred to as target setting information for convenience of the description. The printing apparatus 10 receives the target setting information from the information processing apparatus and causes the nonvolatile storage section 103 to store the received target setting information. When the setting information has been stored in advance in the printing apparatus 10 before the printing apparatus 10 receives the target setting information, the printing apparatus 10 adds the difference between the target setting information and the setting information stored in advance to the setting information stored in advance or overwrites the setting information stored in advance with the difference. Having caused the nonvolatile storage section 103 to store the target setting information, the printing apparatus 10 sets the target setting information in accordance with a request from the information processing apparatus. That is, when the target setting information contains the printing setting information, the printing apparatus 10 specifies in accordance with the request a storage area where the printing setting information has been stored in the firmware as a destination to which the firmware refers about the printing setting information when the printing apparatus 10 performs printing. When the target setting information contains the communication setting information, the printing apparatus 10 specifies in accordance with the request a storage area where the communication setting information has been stored in the firmware as a destination to which the firmware refers about the communication setting information when the printing apparatus 10 performs communication. When the target setting information contains the firmware information, the printing apparatus 10 installs firmware or updates the firmware in accordance with the request. A method for setting the target setting information in the printing apparatus 10 via the information processing apparatus as described above is a well-known method. The user can set desired setting information in the printing apparatus 10 connected to a POS (point of sale) terminal by using the aforementioned method via the information processing apparatus. The user can further set the setting information set in a new printing apparatus 10 that replaces an old printing apparatus 10 connected to a POS terminal the setting information set in the old printing apparatus 10 by using the aforementioned method via the information processing apparatus. That is, the user can use the method described above to hand over the setting information set in the old printing apparatus 10 to the new printing apparatus 10.

In a case where there are a plurality of printing apparatuses 10 to be exchanged, however, the time and effort required to set the setting information in the new printing apparatuses 10 by using the method described above via the information processing apparatus increase as the number of printing apparatuses 10 to be exchanged increases. To solve the problem described above, the printing apparatus 10, when starting acting as the storage, sets without accepting operation from the user the setting information stored from the external apparatus 30 when the printing apparatus 10 acts as the storage.

Specifically, the printing apparatus 10 acting as the storage waits until the printing apparatus 10 receives the setting information from the external apparatus 30 connected to the printing apparatus 10. Upon reception of the setting information from the external apparatus 30, the printing apparatus 10 causes the nonvolatile storage section 103 to store the received setting information. The external apparatus 30 that transmits the setting information to the printing apparatus 10 may be the information processing apparatus or the second printing apparatus, such as another printing apparatus 10. When the external apparatus 30 that transmits the setting information to the printing apparatus 10 is the information processing apparatus, however, the information processing apparatus transmits the setting information to the printing apparatus 10 in accordance with operation accepted from the user. On the other hand, when the external apparatus 30 that transmits the setting information to the printing apparatus 10 is the second printing apparatus, the second printing apparatus transmits the setting information to the printing apparatus 10 in response to a trigger representing that a predetermined first condition is satisfied. The predetermined first condition is, for example, reception of the storage information from the printing apparatus 10 or reception of a request of acquisition of the setting information from the printing apparatus 10, but not limited thereto. Therefore, when the second printing apparatus is connected to the printing apparatus 10, the printing apparatus 10 may transmit the storage information to the second printing apparatus and then transmit the request of acquisition of the setting information to the second printing apparatus.

The second printing apparatus is a printing apparatus having the function of the printing apparatus 10. More specifically, the second printing apparatus is a printing apparatus that has at least the functions of the processor 101 and acts as either the storage or the device. For example, the second printing apparatus may be another printing apparatus 10, as described above. The situation in which the second printing apparatus transmits the setting information to the printing apparatus 10 in response to the trigger representing that the predetermined first condition is satisfied therefore means that the printing apparatus 10 also transmits the setting information to the second printing apparatus connected as the external apparatus 30 in response to the trigger representing that the predetermined first condition is satisfied. The printing apparatus 10 may be configured to transmit while acting as the device the setting information to the second printing apparatus connected as the external apparatus 30 in response to the trigger representing that the predetermined first condition is satisfied or may be configured to transmit while acting as the storage the setting information to the second printing apparatus connected as the external apparatus in response to the trigger representing that the predetermined first condition is satisfied, or the two configurations described above may be combined with each other. The following description will be made, by way of example, of the case where the printing apparatus 10 transmits while acting as the device the setting information to the second printing apparatus connected as the external apparatus 30 in response to the trigger representing that the predetermined first condition is satisfied.

The printing apparatus 10 that causes while acting as the storage the nonvolatile storage section 103 to store the setting information, when powered on by the first electric power from the external power supply 20, starts the action as the device and sets the setting information stored in the nonvolatile storage section 103 without accepting operation from the user. That is, when the setting information contains the printing setting information, the printing apparatus 10 having started acting as the device specifies the storage area where the printing setting information has been stored in the firmware as the destination to which the firmware refers about the printing setting information when the printing apparatus 10 performs printing. When the setting information contains the communication setting information, the printing apparatus 10 specifies the storage area where the communication setting information has been stored in the firmware as the destination to which the firmware refers about the communication setting information when the printing apparatus 10 performs communication. When the target setting information contains the firmware information, the printing apparatus 10 installs firmware or updates the firmware.

As described above, the printing apparatus 10 can set the setting information set in the second printing apparatus as the setting information set in the printing apparatus 10 itself without accepting operation from the user by connecting the printing apparatus 10 while acting as the storage to the second printing apparatus and then causing the printing apparatus 10 to act as the device again. As a result, for example, even when a plurality of printing apparatuses 10 each connected to a POS terminal are exchanged, the time and effort required to set the setting information in the new printing apparatuses 10 can be reduced.

A variety of pieces of information are stored in the form of one or more files in the nonvolatile storage section 103 of the printing apparatus 10. Information is then read from and written on the nonvolatile storage section 103 on a file basis. Therefore, when the information processing apparatus is connected as the external apparatus 30 to the printing apparatus 10 acting as the storage, the user can write the setting information in the form of one or more files on at least part of the storage area of the nonvolatile storage section 103 of the printing apparatus 10 via the information processing apparatus and can read the setting information in in the form of one or more files from at least part of the storage area via the information processing apparatus. The printing apparatus 10 can thus readily back up, restore, and otherwise process the setting information set in the printing apparatus 10. The user can, for example, use the information processing apparatus to read the setting information set in an old printing apparatus 10 connected to a POS terminal from the old printing apparatus 10 and cause a new printing apparatus 10 to store the read setting information to set the setting information in the new printing apparatus 10.

Process of Prohibiting Printing Apparatus from Acting as Storage

The printing apparatus 10 acting as the storage can readily rewrite the setting information via the external apparatus 30, as described above. This leads to an increased possibility of unintentional rewriting of the setting information. To avoid the problem described above, the printing apparatus 10 does not act as the storage when a predetermined prohibition condition is satisfied. For example, a situation in which the unintentional rewriting of the setting information is not desired is a situation in which the printing apparatus 10 is connected to a POS terminal and the user is actually using the printing apparatus 10 as the device. The predetermined prohibition condition that allows suppression of the possibility of the unintentional rewriting of the setting information in such a situation is, for example, that the first electric power is supplied to the first connector 18 of the printing apparatus 10. The reason for this is that the external power supply 20 must be connected to each printing apparatus 10 connected to a POS terminal via the first cable C1 in such a situation even when the state of the power switch 16 of each of the printing apparatuses 10 varies. The predetermined prohibition condition may be another condition. The following description will be made of the case where the first electric power is supplied to the first connector 18 of the printing apparatus 10.

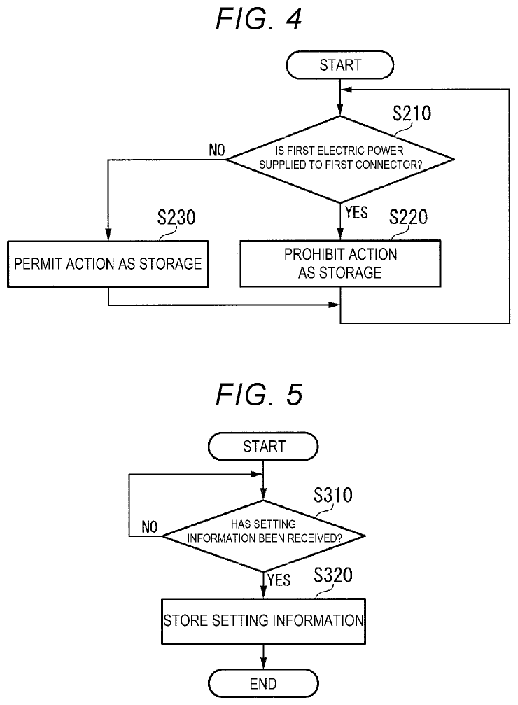

FIG. 4 shows an example of the procedure of the process of prohibiting the printing apparatus 10 from acting as the storage. The following description will be made, by way of example, of a case where the first or second electric power is supplied to the printing apparatus 10 at a timing before the process in step S210 shown in FIG. 4 is carried out.

The processor 101 evaluates whether or not the first electric power is supplied to the first connector 18 (step S210) . It is noted that the processor 101 operates by using the first or second electric power supplied to the printing apparatus 10 in the period for which the process in step S210 is carried out. The detection section S is, for example, a circuit that generates an interrupt signal based on the first electric power supplied to the first connector 18 and outputs the generated interrupt signal to the processor 101 when the first electric power is supplied to the first connector 18. In this case, when the processor 101 acquires the interrupt signal from the detection section S, the processor 101 determines that the first electric power is supplied to the first connector 18. When the processor 101 does not acquire the interrupt signal from the detection section S, the processor 101 determines that the first electric power is not supplied to the first connector 18. The processor 101 can therefore determine that the first electric power is supplied to the first connector 18 when the printing apparatus 10 is connected to the external power supply 20 via the first cable C1 even when the state of the power switch 16 is off.

When the result of the evaluation shows that the first electric power is supplied to the first connector 18 (YES in step S210), the processor 101 prohibits the printing apparatus 10 from acting as the storage (step S220) . In the state in which the action as the storage is prohibited, when the first electric power is not supplied from the external power supply 20 but the second electric power is supplied from the external apparatus 30 via the second connector 19, the printing apparatus 10 is not activated. After the process in step S220 is carried out, the processor 101 transitions to step S210 and evaluates again whether or not the first electric power is supplied to the first connector 18.

On the other hand, when the result of the evaluation shows that the first electric power is not supplied to the first connector 18 (NO in step S210) , the processor 101 permits the printing apparatus 10 to act as the storage (step S230). In the state in which the action as the storage is permitted, when the first electric power is not supplied from the external power supply 20 but the second electric power is supplied from the external apparatus 30 via the second connector 19, the printing apparatus 10 is activated as the storage. After the process in step S230 is carried out, the processor 101 transitions to step S210 and evaluates again whether or not the first electric power is supplied to the first connector 18.

As described above, the printing apparatus 10 does not act as the storage when the detection section S detects that the first electric power is supplied to the first connector 18. The printing apparatus 10 can thus suppress unintentional rewriting of the setting information.

A description will next be made of a case where the printing apparatus 10 acting as the storage receives the setting information from the external apparatus 30 and the process of causing the printing apparatus 10 to store the received setting information with reference to FIG. 5. FIG. 5 shows the case where the printing apparatus 10 acting as the storage receives the setting information from the external apparatus 30 and an example of the procedure of the process of causing the printing apparatus 10 to store the received setting information. The following description will be made, by way of example, of a case where the external apparatus 30 is connected to the printing apparatus 10 via the second cable C2 at a timing before the process in step S310 shown in FIG. 5 is carried out. The following description will further be made, byway of example, of a case where the supply of the first electric power to the printing apparatus 10 has not yet been initiated but the supply of the second electric power to the printing apparatus 10 has been initiated. That is, the following description will be made, by way of example, of a case where the printing apparatus 10 starts acting as the storage at the timing described above.

The processor 101 waits until it receives the setting information from the external apparatus 30 (step S310).

When the result of the evaluation shows that the processor 101 has received the setting information from the external apparatus 30 (YES in step S210), the processor 101 causes the nonvolatile storage section 103 to store the received setting information (step S220) and terminates the process in the flowchart shown in FIG. 5.

As described above, when the first electric power is not supplied from the external power supply 20, and when the second electric power is supplied from the external apparatus 30 via the second connector 19, the printing apparatus 10 acts as the storage, and thereafter, when the printing apparatus 10 receives the setting information to be set in the printing apparatus 10 from the external apparatus 30, the printing apparatus 10 causes the nonvolatile storage section 103 to store the received setting information. The printing apparatus 10 can thus set the setting information set in the second printing apparatus as the setting information to be set in the printing apparatus 10 itself without accepting operation from the user, for example, by connecting the printing apparatus 10 while acting as the storage to the second printing apparatus and then causing the printing apparatus 10 to act as the device again, as described above. As a result, for example, even when a plurality of printing apparatuses 10 each connected to a POS terminal are exchanged, the time and effort required to set the setting information in the new printing apparatuses 10 can be reduced.

When a predetermined second condition is satisfied, the processor 101 may start the process in step S310. The predetermined second condition is, for example, that the external apparatus 30 connected to the printing apparatus 10 is the second printing apparatus and the second printing apparatus is older than the printing apparatus 10. In this case, the printing apparatus 10 acquires the device information from the second printing apparatus after the second printing apparatus is connected to the printing apparatus 10. After the acquisition of the device information, the printing apparatus 10 transmits a request to acquire information representing a use history stored in the second printing apparatus to the second printing apparatus. The printing apparatus 10 thus acquires the information and evaluates based on the acquired information whether or not the second printing apparatus connected to the printing apparatus 10 is older than the printing apparatus 10. The information is, for example, information representing the number of years for which the second printing apparatus has been used, the number at which the second printing apparatus has been used, and other factors. The predetermined second condition may instead be acceptance of operation of initiating reception of the setting information from the second printing apparatus. The operation is, for example, operation of pressing the switch 15d predetermined times but not necessarily. In this case, the printing apparatus 10 accepts the operation and transmits the request to acquire the setting information to the second printing apparatus. When the predetermined second condition is acceptance of operation of initiating reception of the setting information from the second printing apparatus, the printing apparatus 10 may be configured to print an image containing information that prompts the user to evaluate whether or not reception of the setting information from the second printing apparatus is initiated. The information is, for example, “Do you want to copy the setting information set in the connected printer to this printer? If yes, press Feed button twice.” This printer is the printing apparatus 10. The connected printer is the second printing apparatus. The Feed button is the switch 15d.

### Process of Causing Printing Apparatus Acting as Device to Transmit Setting Information to Second Printing Apparatus

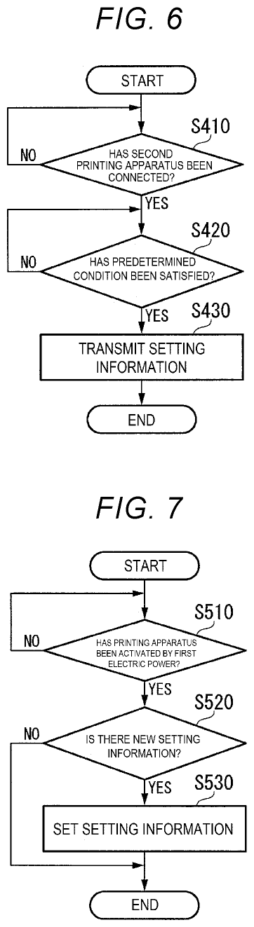

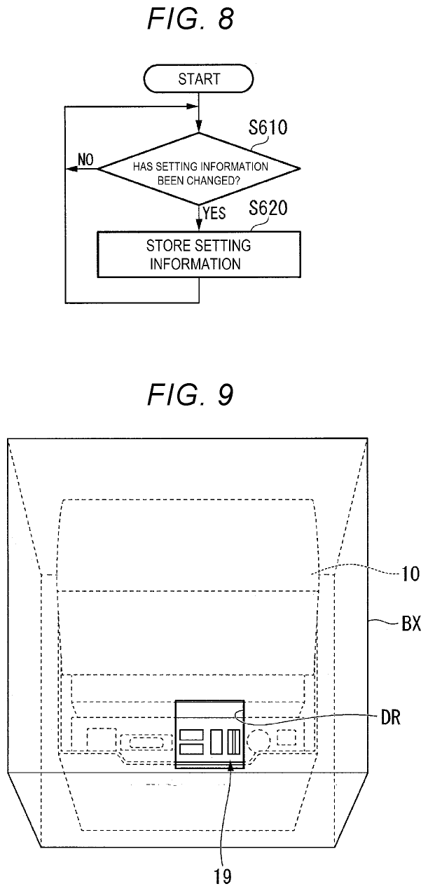

As described above, when the second printing apparatus is connected as the external apparatus 30 to the printing apparatus 10 acting as the device, the printing apparatus 10 transmits the setting information to the second printing apparatus in response to the trigger representing that the predetermined first condition is satisfied. The following description will be made of the case where the second printing apparatus is connected as the external apparatus 30 to the printing apparatus 10 and the process of causing the printing apparatus 10 to transmit the setting information to the second printing apparatus in response to the trigger representing that the predetermined first condition is satisfied with reference to FIG. 6. FIG. 6 shows the case where the second printing apparatus is connected as the external apparatus 30 to the printing apparatus 10 and an example of the procedure of the process of causing the printing apparatus 10 to transmit the setting information to the second printing apparatus in response to the trigger representing that the predetermined first condition is satisfied. The following description will be made, by way of example, of a case where the supply of the first electric power to the printing apparatus 10 is initiated at a timing before the process in step S610 shown in FIG. 8 is carried out. That is, the following description will be made, by way of example, of a case where the printing apparatus 10 starts acting as the device at the timing described above. The following description will further be made, by way of example, of a case where the external apparatus 30 is the second printing apparatus.

The processor 101 waits until the second printing apparatus is connected to the printing apparatus 10 via the second cable C2 (step S410) . The processor 101 may evaluate by using any method whether or not the connected external apparatus 30 is the second printing apparatus when the printing apparatus 10 acts as the device.

When the result of the evaluation shows that the second printing apparatus is connected to the printing apparatus 10 via the second cable C2 (YES in step S410), the processor 101 transmits the device information to the second printing apparatus. The processor 101 then waits until the predetermined first condition is satisfied (step S420).

The predetermined first condition is, for example, reception of the storage information from the second printing apparatus connected to the printing apparatus 10. In this case, the processor 101 transmits the setting information set in the printing apparatus 10 to the second printing apparatus when the printing apparatus 10 receives the storage information from the second printing apparatus connected to the printing apparatus 10. The predetermined first condition may instead be that the second printing apparatus connected to the printing apparatus 10 is newer than the printing apparatus 10. In this case, the printing apparatus 10 evaluates whether or not the second printing apparatus connected to the printing apparatus 10 is newer than the printing apparatus 10 based on the information representing the use history stored in the second printing apparatus. The information representing the use history is, for example, the information representing the number of years for which the second printing apparatus has been used, the number at which the second printing apparatus has been used, and other factors. When the second printing apparatus stores the information representing the use history, the printing apparatus 10 stores the information representing the use history in the nonvolatile storage 103. The predetermined first condition may be acceptance of operation of initiating transmission of the setting information set in the printing apparatus 10 to the second printing apparatus. The operation is, for example, the operation of pressing the switch 15d predetermined times but not necessarily. When the predetermined first condition is acceptance of operation of initiating transmission of the setting information set in the printing apparatus 10 to the second printing apparatus, the printing apparatus 10 may be configured to print an image containing information that prompts the user to evaluate whether or not transmission of the setting information set in the printing apparatus 10 to the second printing apparatus is initiated in step S420. The information is, for example, “Do you want to copy the setting information set in this printer to the connected printer? If yes, press Feed button once.” This printer is the printing apparatus 10. The connected printer is the second printing apparatus. The Feed button is the switch 15d.

When the result of the evaluation shows that the predetermined first condition is satisfied (YES in step S420), the processor 101 transmits the setting information stored in the nonvolatile storage section 103 as the setting information set in the printing apparatus 10 to the second printing apparatus (step S430) and terminates the process in the flowchart shown in FIG. 6.

As described above, when the second printing apparatus is connected to the printing apparatus 10 acting as the device, the printing apparatus 10 transmits the setting information set in the printing apparatus 10 to the second printing apparatus in response to the trigger representing that the predetermined first condition is satisfied. The printing apparatus 10 can therefore, for example, be connected to the second printing apparatus while acting as the device and can transmit the setting information set in the printing apparatus 10 to the second printing apparatus without accepting operation from the user, as described above. As a result, for example, even when a plurality of printing apparatuses 10 each connected to a POS terminal are exchanged, the time and effort required to set the setting information in the new printing apparatuses 10 can be reduced.

The printing apparatus 10 may be configured to carry out the process in step S320 shown in FIG. 5 and the process in step S430 shown in FIG. 6 in accordance with operation accepted from the user via the switch 15d. In this case, when the external apparatus 30 is connected to the printing apparatus 10, the processor 101 prints an image containing, for example, both “Do you want to copy the setting information set in the connected printer to this printer? If yes, press Feed button twice.” and “Do you want to copy the setting information set in this printer to the connected printer? If yes, press Feed button once.” irrespective of whether or not the printing apparatus 10 acts as the device. The printing apparatus 10 thus accepts operation according to the user's desired action via the switch 15d and carries out either the process in step S320 shown in FIG. 5 or the process in step S430 shown in FIG. 6 in accordance with the received operation. As a result, the printing apparatus 10 can copy the setting information in a printing apparatus desired by the user, the printing apparatus 10 or the second printing apparatus, also when whether the printing apparatus 10 or the second printing apparatus is a newer printing apparatus cannot be evaluated.

The printing apparatus 10 may be configured to check suitability of whether or not copying the setting information set in the printing apparatus 10 and setting the copied setting information in the second printing apparatus or vice versa causes a problem in the handover of the setting information between the printing apparatus 10 and the second printing apparatus. In this case, information representing the model and other factors of the printing apparatus 10 is stored in the nonvolatile storage section 103 of the printing apparatus 10. The printing apparatus 10 can thus check the suitability. The suitability check may be performed in combination, for example, with unique encryption of the setting information or an electronic signature to suppress computer virus invasion, copying of an unauthorized file, and the like.

### Process of Causing Printing Apparatus to Set Setting Information Stored in Nonvolatile Storage Section of Printing Apparatus

The process of causing the printing apparatus 10 to set the setting information stored in the nonvolatile storage section 103 of printing apparatus 10 will be described. FIG. 7 shows an example of the procedure of the process of causing the printing apparatus 10 to set the setting information stored in the nonvolatile storage section 103 of printing apparatus 10.

The processor 101 waits until the printing apparatus 10 is activated by the first electric power (step S510).

When the result of the evaluation shows that the printing apparatus 10 has been activated by the first electric power (YES in step S510), the processor 101 evaluates whether or not there is new setting information (step S520). For example, when the processor 101 determines based on the history of the storage on the nonvolatile storage section 103 that new information is added to overwrites the setting information stored in advance or that new information is stored as new setting information, the processor 101 determines that there is new setting information.

When the result of the evaluation shows that there is no new setting information (NO in step S520), the processor 101 determines that the setting information having already been set is the latest setting information and terminates the process in the flowchart shown in FIG. 7.

On the other hand, when the processor 101 determines that there is new setting information (YES in step S520), the processor 101 sets the setting information stored in the nonvolatile storage section 103 (step S530) and terminates the process in the flowchart shown in FIG. 7.

As described above, the printing apparatus 10, when activated by the first electric power from the external apparatus 30, sets the setting information stored in the nonvolatile storage section 103. The printing apparatus 10 can thus set the setting information newly stored in the printing apparatus 10 without accepting operation from the user. As a result, the printing apparatus 10 can set the setting information set in the second printing apparatus as the setting information to be set in the printing apparatus 10 itself without accepting operation from the user, for example, by connecting the printing apparatus 10 while acting as the storage to the second printing apparatus and then causing the printing apparatus 10 to act as the device again, as described above. That is, for example, even when a plurality of printing apparatuses 10 each connected to a POS terminal are exchanged, the time and effort required to set the setting information in the new printing apparatuses 10 can be reduced.

### Process of Causing Printing Apparatus to Update Setting Information When Set Setting Information is Changed

The setting information set in the printing apparatus 10 is changed in some cases via the information processing apparatus connected as the external apparatus 30 without any change in the setting information stored in the nonvolatile storage section 103. Therefore, when the setting information set in the printing apparatus 10 is changed, the printing apparatus 10 causes the nonvolatile storage section 103 to store the changed setting information as new setting information. That is, in this case, the printing apparatus 10 updates the setting information stored in the nonvolatile storage section 103. The process of causing the printing apparatus 10 to update the setting information when the set setting information is changed will be described below with reference to FIG. 8. It is, however, noted that the update is performed while the printing apparatus 10 acts as the device.

FIG. 8 shows an example of the procedure of the process of causing the printing apparatus 10 to update the setting information when the set setting information is changed. The following description will be made, by way of example, of a case where the printing apparatus 10 starts acting as the device at a timing before the process in step S610 shown in FIG. 8 is carried out.

The processor 101 evaluates whether or not the set setting information has been changed (step S610). The processor 101, for example, compares the setting information stored in the nonvolatile storage section 103 with the setting information currently set in the printing apparatus 10 and determines that the set setting information has been changed when the two types of setting information differ from each other. On the other hand, the processor 101, for example, compares the setting information stored in the nonvolatile storage section 103 with the setting information currently set in the printing apparatus 10 and determines that the set setting information has been not changed when the two types of setting information do not differ from each other.

When the processor 101 determines that the set setting information has not been changed (NO in step S610), the processor 101 transitions to step S610 and evaluates again whether or not the set setting information has been changed.

On the other hand, when the processor 101 determines that the set setting information has been changed (YES in step S610), the processor 101 stores the setting information currently set in the printing apparatus 10 again as new setting information in the nonvolatile storage section 103 (step S620). The processor 101 then transitions to step S610 and evaluates again whether or not the set setting information has been changed.

As described above, when the setting information set in the printing apparatus 10 is changed, the printing apparatus 10 updates the setting information stored in the nonvolatile storage section 103. The printing apparatus 10 can thus suppress a situation in which the setting information stored in the nonvolatile storage section 103 differs from the setting information currently set in the printing apparatus 10.

### Method for Storing Setting Information in Printing Apparatus Packed in Storage Box Before Shipment

A method for storing the setting information in the printing apparatus 10 packed in a storage box before shipment will be described below. The setting information can be stored in the printing apparatus 10 without connecting the external power supply 20 to the printing apparatus 10 but by connecting the external apparatus 30 to the printing apparatus 10 via the second cable C2, as described above. That is, this means that the setting information can be stored in the printing apparatus 10 without taking out the printing apparatus 10 packed in the storage box from the storage box before shipment, as will be described below.

FIG. 9 shows an example of the printing apparatus 10 packed in the storage box. A storage box BX shown in FIG. 9 is an example of the storage box for packing the printing apparatus 10. That is, in the example shown in FIG. 9, the printing apparatus 10 is packed in the storage box BX. The storage box BX is, for example, a cardboard box. The storage box BX is provided with an openable and closable window DR. The storage box BX may be a box made of another material in place of a cardboard box. The window DR may have any configuration that allows the window DR to be opened and closed with the user's hand with respect to a surface of the storage box BX that is the surface where the window DR is provided. As shown in FIG. 9, when the printing apparatus 10 is packed in the storage box BX, the second connector 19 of the printing apparatus 10 is in a position visible when the window DR is opened. In other words, the window DR is so provided as part of the storage box BX that the second connector 19 is located in a position visible when the window DR is opened in the case described above. In this case, a person who uses the external apparatus 30 to set the setting information in the printing apparatus 10 can connect the second cable C2 to the second connector 19 by opening the window DR without taking out the printing apparatus 10 from the storage box BX. As a result, the person can connect the printing apparatus 10 to the external apparatus 30 via the second cable C2. That is, the person can store the setting information in the printing apparatus 10 by using the external apparatus 30 without taking out the printing apparatus 10 packed in the storage box BX from the storage box BX before shipment. The person can then set the setting information in the printing apparatus 10 by using the external apparatus 30 without taking out the printing apparatus 10 packed in the storage box BX from the storage box BX before shipment. The person is, for example, a system integrator, but not limited thereto. The window DR is an example of an opening/closing section.

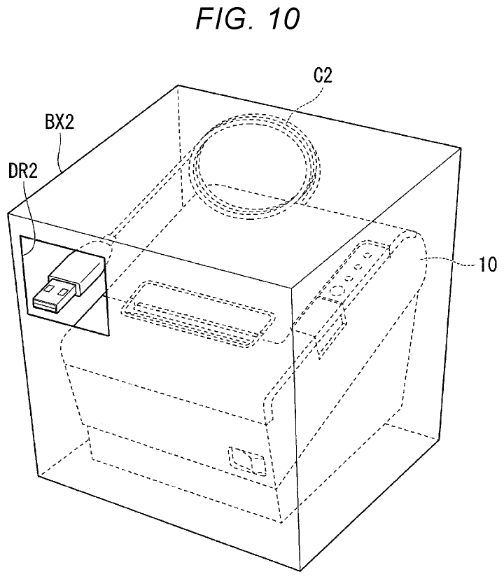

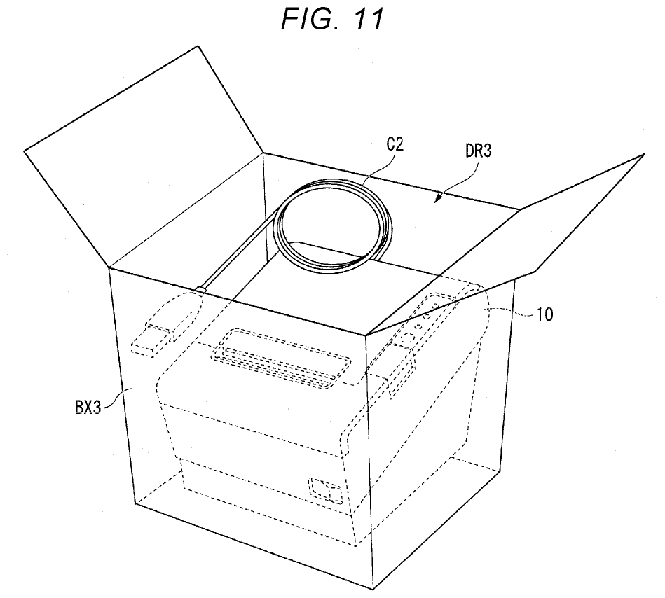

FIG. 10 shows an example of the printing apparatus 10 packed in a storage box. A storage box BX2 shown in FIG. 10 is another example of the storage box for packing the printing apparatus 10. That is, in the example shown in FIG. 10, the printing apparatus 10 is packed along with the second cable C2 connected to the second connector 19 in the storage box BX2. The storage box BX2 is, for example, a cardboard box. The storage box BX2 is provided with an openable and closable window DR2. The storage box BX2 may be a box made of another material in place of a cardboard box. The window DR2 may have any configuration that allows the window DR2 to be opened and closed with the user's hand with respect to a surface of the storage box BX2 that is the surface where the window DR2 is provided. As shown in FIG. 10, when the printing apparatus 10 is packed in the storage box BX2, the second cable C2 connected to the second connector 19 is in a position visible when the window DR2 is opened. In other words, the window DR2 is so provided as part of the storage box BX2 that the second cable C2 connected to the second connector 19 is located in a position visible when the window DR2 is opened in the case described above. In this case, a person who uses the external apparatus 30 to set the setting information in the printing apparatus 10 can draw out the second cable C2 by opening the window DR2 without taking out the printing apparatus 10 from the storage box BX2. The person can then connect the drawn-out second cable C2 to the external apparatus 30. As a result, the person can connect the printing apparatus 10 to the external apparatus 30 via the second cable C2. That is, the person can store the setting information in the printing apparatus 10 by using the external apparatus 30 without taking out the printing apparatus 10 packed in the storage box BX2 from the storage box BX2 before shipment. The person can then set the setting information in the printing apparatus 10 by using the external apparatus 30 without taking out the printing apparatus 10 packed in the storage box BX2 from the storage box BX2 before shipment. The person is, for example, a system integrator, but not limited thereto. The window DR2 is an example of the opening/closing section.

FIG. 11 shows still another example of the printing apparatus 10 packed in the storage box. A storage box BX3 shown in FIG. 11 is another example of the storage box for packing the printing apparatus 10. That is, in the example shown in FIG. 11, the printing apparatus 10 is packed along with the second cable C2 connected to the second connector 19 in the storage box BX3. The storage box BX3 is, for example, a cardboard box. The storage box BX3 is provided with an opening/closing section DR3, which is openable and closable. The storage box BX3 may be a box made of another material in place of a cardboard box. The opening/closing section DR3 is, for example, a lid that forms one of the surfaces of the storage box BX3 and allows the surface to be open and closed. When the printing apparatus 10 is packed in the storage box BX3, the second cable C2 connected to the second connector 19 is in a position visible when the opening/closing section DR3 is opened, as shown in FIG. 11. In other words, the opening/closing section DR3 is so provided as part of the storage box BX3 that the second cable C2 connected to the second connector 19 is located in a position visible when the opening/closing section DR3 is opened in the case described above. In this case, a person who uses the external apparatus 30 to set the setting information in the printing apparatus can draw out the second cable C2 by opening the opening/closing section DR3 without taking out the printing apparatus 10 from the storage box BX3. The person can then connect the drawn-out second cable C2 to the external apparatus 30. As a result, the person can connect the printing apparatus 10 to the external apparatus 30 via the second cable C2. That is, the person can store the setting information in the printing apparatus 10 by using the external apparatus 30 without taking out the printing apparatus 10 packed in the storage box BX3 from the storage box BX3 before shipment. The person can then set the setting information in the printing apparatus 10 by using the external apparatus 30 without taking out the printing apparatus 10 packed in the storage box BX3 from the storage box BX3 before shipment. The person is, for example, a system integrator, but not limited thereto. The opening/closing section DR3 is an example of the opening/closing section.

As described above, the printing apparatus according to the embodiment is a printing apparatus that is communicable with an external apparatus and performs printing by using first electric power supplied from an external power supply. The printing apparatus includes a storage section, a connector to which a cable used both to communicate with the external apparatus and supply second electric power from the external apparatus is connected, and a control section. The control section transmits information representing that the printing apparatus acts as a storage that stores information in the storage section to the external apparatus when the first electric power is not supplied from the external power supply but the second electric power is supplied from the external apparatus via the connector and transmits information representing that the printing apparatus acts as a device that performs printing to the external apparatus when the first electric power is supplied from the external power supply. The printing apparatus can thus readily write the setting information on the storage section. In the example described above, the printing apparatus 10 is an example of a printing apparatus. In the example described above, the external apparatus 30 is an example of an external apparatus. In the example described above, the nonvolatile storage section 103 is an example of the storage section. In the example described above, the second cable C2 is an example of the cable. In the example described above, the second connector 19 is an example of the connector. In the example described above, the processor 101 is an example of the control section. In the example described above, the storage information is an example of the information representing that the printing apparatus acts as a storage that stores information in the storage section. In the example described above, the device information is an example of the information representing that the printing apparatus acts as a device that performs printing.

In the printing apparatus, the control section may be configured to act as the storage when the first electric power is not supplied from the external power supply but the second electric power is supplied from the external apparatus via the connector and then cause the storage section, when setting information to be set in the printing apparatus is received from the external apparatus, to store the setting information.

In the printing apparatus, the external apparatus may be a second printing apparatus that has at least the function of the control section and acts as either the storage that stores information in the storage section or the device that performs printing, and the control section may be configured to act as the storage when the first electric power is not supplied from the external power supply but the second electric power is supplied from the second printing apparatus via the connector and then cause the storage section, when second setting information set in the second printing apparatus is received from the second printing apparatus, to store the received second setting information as the setting information. In the example described above, the other printing apparatus 10 and the printing apparatus having upward compatibility with the printing apparatus 10 are each an example of the second printing apparatus.

In the printing apparatus, the external apparatus may be a third printing apparatus that has at least the function of the control section and acts as either the storage that stores information in the storage section or the device that performs printing, and the control section may be configured to act as the device and transmit the setting information stored in the storage section to the third printing apparatus when the first electric power is supplied from ₜhe external power supply and the printing apparatus is connected to the third printing apparatus via the cable. In the example described above, the other printing apparatus 10 and the printing apparatus having upward compatibility with the printing apparatus 10 are each an example of the third printing apparatus.

In the printing apparatus, the storage section may be configured to store the setting information in the form of one or more files, and information may be read from and written on the storage section on a file basis.

In the printing apparatus, the setting information may contain update information for updating the firmware of the printing apparatus, and the control section may be configured to act as the device when the setting information containing the update information is stored in the storage section and the printing apparatus is activated by the first electric power from the external power supply and read the update information from the storage section to update the firmware.

The printing apparatus may further include a power supply connector to which a power supply cable used to supply the first electric power from the external power supply is connected and a detection section that detects that the first electric power is supplied to the power supply connector, and the control section may be configured not to act as the storage when the detection section detects that the first electric power is supplied to the power supply connector. In the example described above, the first cable C1 is an example of the power supply cable. In the example described above, the first connector is an example of the power supply connector. In the example described above, the detection section S is an example of a detection section.

The printing apparatus may be packed in a storage box having an opening/closing section before shipment, and the connector may be configured to be located in a position visible from a position outside the storage box when the printing apparatus is accommodated in the storage box and the opening/closing section is opened. In the example described above, the windows DR1, DR2, and the opening/closing section DR3 are each an example of the opening/closing section. In the example described above, the storage boxes BX1, BX2, and BX3 are each an example of the storage box.

An embodiment of the present disclosure has been described above in detail with reference to the drawings, but the specific configuration of the embodiment is not limited to that of the embodiment, and changes, replacements, omissions, and other modifications may be made thereto to the extent that the changes, replacements, omissions, and other modifications do not depart from the substance of the present disclosure.

A program for achieving the function of an arbitrary constituent portion of the apparatus described above may be recorded on a computer readable recording medium, and the program may be read and executed by a computer system. The apparatus is, for example, the printing apparatus 10 or the external apparatus 30. It is noted that the “computer system” used herein includes an OS (Operating System) and hardware, such as peripheral instruments. Further, the “computer-readable recording medium” refers to a portable medium, such as a flexible disk, a magneto-optical disk, a ROM, and a CD-ROM (Compact-Disk-ROM), or a storage apparatus, such as a hard disk built in a computer system. Further, the “computer readable recording medium” is assumed to encompass a component that holds a program for a fixed period, such as a volatile memory in a computer system that works as a server or a client when the program is transmitted over the Internet or any other network or a telephone circuit or any other communication circuit.

The program described above may be transmitted from the computer system including the storage apparatus or any other component that stores the program to another computer system via a transmission medium or a transmission wave traveling through a transmission medium. The term “transmission medium” used herein, through which the program is transmitted, refers to a medium having the function of transmitting information, such as the Internet and other networks and a telephone circuit and other communication circuits.

The program described above may instead be a program that achieves part of the functions described above. The program described above may still instead be a program that can achieve the functions described above when combined with a program having already been recorded in the computer system, that is, what is called a difference file or a difference program.

What is claimed is:

1. A printing apparatus that is communicable with an external apparatus and performs printing by using first electric power supplied from an external power supply, the printing apparatus comprising:
a storage section;
a connector which is connectable to a cable and to which second electric power is supplied from the external apparatus via the cable; and
a control section,
wherein the control section
acts as a storage that stores information in the storage section when the first electric power is not supplied from the external power supply but the second electric power is supplied from the external apparatus via the connector, and
acts as a device that performs the printing when the first electric power is supplied from the external power supply.

2. The printing apparatus according to claim 1,
wherein the control section act as the storage when the first electric power is not supplied from the external power supply but the second electric power is supplied from the external apparatus via the connector and then causes the storage section, when setting information to be set in the printing apparatus is received from the external apparatus, to store the setting information.

3. The printing apparatus according to claim 2,
wherein the external apparatus is a second printing apparatus that has at least a function of the control section and acts as either the storage that stores information in the storage section or the device that performs the printing, and
the control section acts as the storage when the first electric power is not supplied from the external power supply but the second electric power is supplied from the second printing apparatus via the connector and then causes the storage section, when second setting information set in the second printing apparatus is received from the second printing apparatus, to store the received second setting information as the setting information.

4. The printing apparatus according to claim 2,
wherein the external apparatus is a third printing apparatus that has at least a function of the control section and acts as either the storage that stores information in the storage section or the device that performs the printing, and
the control section acts as the device and transmits the setting information stored in the storage section to the third printing apparatus when the first electric power is supplied from the external power supply and the printing apparatus is connected to the third printing apparatus via the cable.

5. The printing apparatus according to claim 2,
wherein the storage section stores the setting information in a form of one or more files, and information is read from and written on the storage section on a file basis.

6. The printing apparatus according to claim 2,
wherein the setting information contains update information for updating firmware of the printing apparatus, and
the control section acts as the device when the setting information containing the update information is stored in the storage section and the printing apparatus is activated by the first electric power from the external power supply and reads the update information from the storage section to update the firmware.

7. The printing apparatus according to claim 1, further comprising:
a power supply connector to which a power supply cable via which the first electric power is supplied from the external power supply is connected; and
a detection section that detects whether or not the first electric power is supplied to the power supply connector,
wherein the control section does not to act as the storage when the detection section detects that the first electric power is supplied to the power supply connector.

8. The printing apparatus according to claim 1,
wherein the printing apparatus is packed in a storage box having an opening/closing section, and
the connector is located in a position visible from a position outside the storage box when the printing apparatus is accommodated in the storage box and the opening/closing section is opened.

9. A method for controlling a printing apparatus that is communicable with an external apparatus and performs printing by using first electric power supplied from an external power supply, the printing apparatus including a storage section and a connector which is connectable to a cable and to which second electric power is supplied from the external apparatus via the cable, the method for controlling a printing apparatus comprising:
causing the control section to act as a storage that stores information in the storage section when the first electric power is not supplied from the external power supply but the second electric power is supplied from the external apparatus via the connector; and
act as a device that performs the printing when the first electric power is supplied from the external power supply.
